(19) United States
(12) Patent Application Publication
(10) Pub. No.: US 2003/0211334 A1
(43) Pub. Date: Nov. 13, 2003

(54) Low gloss automotive interior laminates

(76) Inventor: Kyle R. Jones, Crown Point, IN (US)

Correspondence Address: CHRISTIE, PARKER & HALE, LLP, 350 WEST COLORADO BOULEVARD, SUITE 500, PASADENA, CA, 91105, US

(21) Appl. No.: 10/139,979

(22) Filed: May 7, 2002

(51) Int. Cl. B32B 27/00; B32B 27/40

(52) U.S. Cl. 428/423.1

(57) ABSTRACT

A low gloss interior automotive laminate has a finish with a tactile property that imparts a soft low friction quality to the finished part surface. The laminate comprises a base coat/clear coat decorative transfer film bonded to a polymeric substrate. The outer clear coat, which provides the functional characteristics of the surface finish, is formed by casting it on a low gloss release coated carrier. The clear coat preferably comprises a water-borne aliphatic urethane dispersion having a low cross-linking density and containing a dispersed flatting agent. The crosslinked polymer provides soft low surface friction properties with improved hardness and tensile strength while maintaining thermoformability. The color coat which comprises a solid color or print pattern is coated on the dry clear coat or on an intervening tie coat for adhesion. The base coat/clear coat film is removed from the carrier and laminated either to a thermoformable polymeric sheet, to a thin polymeric substrate sheet, or to an extruded substrate sheet. The transferred film is shaped by thermoforming or molding it to a three-dimensional configuration under which the outer surface is elongated while maintaining the desired soft tactile finish in combination with a low gloss outer surface having a 60° gloss from about 1 to about 5 gloss units.

### FIELD OF THE INVENTION

This invention relates to the use of dry paint transfer techniques for producing an interior automotive laminate used as a functional interior component for covering instrument panels and the like. More particularly, the invention relates to the production of an extremely low gloss dry paint transfer sheet that can be made into a complex-shaped surfacing component for automotive interiors by conventional transfer lamination and thermoforming techniques. The invention avoids solvent evaporation problems associated with spray painting such interior automotive surfaces.

### BACKGROUND OF THE INVENTION

Automotive interiors present a unique set of problems in the painting of certain components. For example, automotive dashboards can be exposed to high levels of heat and ultraviolet radiation which can detrimentally affect their appearance over time. Furthermore, in order to avoid causing glare, which can be annoying to passengers and dangerous to the driver, low gloss finishes for dashboard surfacing components are desirable.

The present invention provides a low gloss interior finish with a tactile property that imparts a soft, somewhat leather-like quality to the finished part surface. The invention offers an alternative to the methods of decorating interior parts that are currently painted. The painted interior parts have a soft tactile surface property produced by highly crosslinked paint systems, typically two-component polyurethane systems. The article produced by the present invention offers the ability to print patterns, as well as solid colors, a capability not present with paint. The physical performance of the surfacing material is comparable to most soft leather-like interior type paint systems.

The invention includes use of a dry paint transfer laminate in which an outer clear coat layer of the transfer laminate provides the low gloss tactile surface characteristics of the finished part. Such transfer laminates are confronted with problems of adhesion to polymeric substrate paints and maintaining their required functional properties during the process of thermoforming (elongating) them to a finished three-dimensional shape. Such functional properties include weatherability (including UV resistance), scratch and mar resistance, and providing an extremely low gloss outer surface.

### SUMMARY OF THE INVENTION

Briefly, one embodiment of this invention comprises a decorative and functional low gloss interior automotive laminate comprising a thermoformable decorative transfer sheet having a cast urethane outer clear coat layer and an underlying base coat layer containing a dispersed pigment. The laminate further comprises a self-supporting thermoformable resinous sheet adhered to the transfer sheet on a side there opposite from the clear coat. The outer clear coat layer comprises a flatting agent dispersed in a urethane material having a sufficiently low cross-linking density to allow elongation of the outer clear coat layer without significantly disrupting its surface gloss or causing structural failure of the clear coat when undergoing the thermoforming process. The outer clear coat layer has a transferred surface micro-roughness from having been cast on a temporary carrier sheet. The outer surface of the clear coat layer maintains a 60° gloss level from about 1 to about 10 gloss units, and more commonly from about 1 to about 5 gloss units after the laminate is thermoformed to a three-dimensional shape and the carrier is removed from the outer clear coat surface.

These and other aspects of the invention will be more fully understood by referring to the following detailed description and the accompanying drawings.

### BRIEF DESCRIPTION OF THE DRAWINGS

FIG. 1 is a schematic cross-sectional view illustrating the components of one embodiment of a dry paint transfer laminate according to principles of this invention.

FIG. 2 is a schematic elevational view showing one process for laminating the paint film layer of this invention to an extruded sheet.

FIG. 3 is a schematic elevational view illustrating an alternative laminating process.

### DETAILED DESCRIPTION

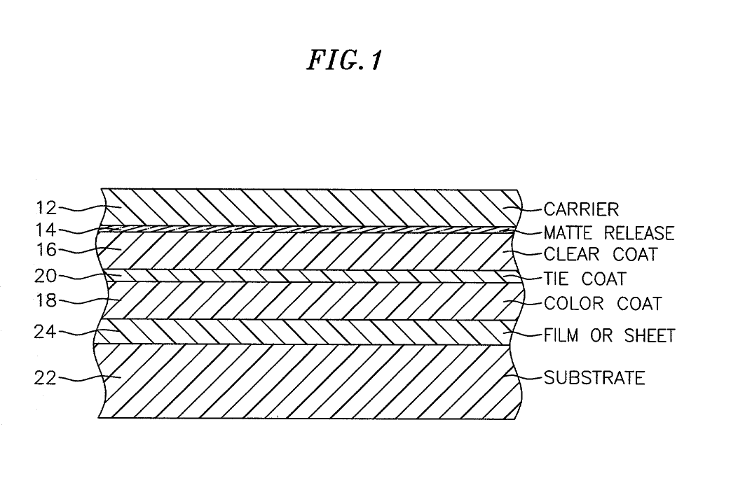

FIG. 1 is a schematic cross-sectional view illustrating a soft, extremely low gloss interior automotive transfer laminate 10 according to principles of this invention. FIG. 1 illustrates the layers of the transfer laminate at an intermediate stage of a process for making the finished part, prior to being thermoformed into a shaped component adapted for covering the mechanical parts of an automotive interior, such as instrument panels, door panels, and the like. This soft laminate is to be distinguished from purely aesthetic interior trim parts which do not have the same rigorous automotive specifications for wear resistance, stain resistance and UV resistance, for example. The soft laminate is made by a multi-stage coating process, in which various layers of the laminate are applied to a temporary casting sheet or carrier 12. The casting sheet has a matte finish provided by a chemical matte layer applied as a low gloss matte release layer 14 to the carrier. The carrier comprises a flexible and foldable, heat resistant, substantially inelastic polymeric film, such as a polyester web on which the matte release layer is coated.

During the process of making the soft laminate, a soft low gloss top coat or outer clear coat layer 16 is first cast on the matte release layer and dried. A color coat layer 18 is then bonded to the clear coat layer. The color coat layer can comprise one or more pigmented coats in solid colors or print coats in various ink patterns to produce a desired decorative appearance, as is well know in the art. The color coat in some instances can be coated directly onto the clear coat layer, or an intervening tie coat 20 can be applied to the clear coat to improve adhesion of the color coat layer to the clear coat.

The clear coat/color coat combination, also referred to in the art as a base coat/clear coat paint film or foil, comprises a decorative transfer foil which can be applied to a substrate sheet by various lamination techniques described below. The embodiment of FIG. 1 shows the base coat/clear coat decorative transfer film bonded to a polymeric substrate sheet 22. The transfer film can be laminated directly to the substrate sheet, or a thin film 24 can be used as an intervening bonding layer for laminating the transfer film to the substrate. The transfer film also can be bonded to a substrate by face laminating it to an extruded substrate sheet, as described below.

The low gloss surface finish of the transfer film is produced in part by casting it on the matte release layer of the polyester carrier film. The matte finish is preferably made by coating a thermoset chemical matte release coat on the temporary carrier sheet. The matte release coat causes a low gloss finish to be replicated onto the outer surface of the top coat which is coated onto the matte surface. When a matte casting sheet is used, the outer clear coat surface of the transfer laminate has a matte finish even before the laminate has been thermoformed. The clear coat layer contains a flatting agent, to be described below, which also in part contributes to the extremely low gloss surface finish of the outer clear coat layer. In a preferred embodiment, the desired low gloss level of the outer clear coat is achieved by a proper balancing of the use of the matte finish casting sheet and the flatting agent in the top coat. A low 60° gloss level below about 10 gloss units is desirable for the finished product, more preferably an extremely low gloss level within the range from about 1 to about 5 gloss units.

The casting sheet can be a biaxially oriented polyester film such as Mylar (trademark of DuPont), or Hoechst Celanese Hostaphan polyester film, or the like. The casting sheet is coated with the matte release coat by conventional methods, such as by roller coating or a gravure printing process.

The preferred matte release coating composition is a thermosetting resinous material which, when exposed to heat during a drying step, becomes crosslinked and permanently bonded as a surface film adhered to the casting sheet. The solids contained in the matte release coat preferably include, as a principal component, one or more crosslinking agents to provide good adhesion of the dried crosslinked coating to the polyester casting sheet. In one embodiment, the matte release coat formulation includes a primary crosslinking resin, such as an acrylic resin that bonds to the casting sheet. A suitable acrylic resin is an acrylic polyol known as Desmophen A450. The matte release coat also includes a secondary crosslinking resin to improve release of the top coat from the matte release coat. In one embodiment, the secondary crosslinking resin can be a liquid hexamethoxy-methylmelamine crosslinking resin. The matte release coat further includes a catalyst for accelerating the crosslinking process which, in one embodiment, comprises a PTSA catalyst, and a polysiloxane resin, which links into the system and crosslinks for providing a flow additive and release aid for the matte release coat.

The resinous components of the matte release coat composition are mixed with suitable solvents for application to the casting sheet. In one embodiment, the resins are mixed with a first resin solvent such as methyl isobutyl ketone (MIBK) and a second resin solvent such as isopropyl alcohol (IPOH) which is useful in retarding crosslinking of the resins in solution. The matte release coat formulation is prepared by dissolving the primary crosslinking resins in the solvents by mixing and then adding the secondary crosslinking resin, together with a matting agent. The matting agent comprises a filler in the form of a fine particulate inert inorganic material. In one embodiment, the filler comprises talc, although other fillers such as aluminum silicate can be used. The filler contained in the formulation comprises up to about 50 percent of the total solids in the matte release coat. The fine particulate filler is thoroughly dispersed in the resin and resin solvent blend under elevated temperatures. When the matte release layer dries and crosslinks, it forms a chemical matte coating on the surface of the carrier sheet. The matte release surface is controlled by the amount and particle size of the filler. In one embodiment the average particle size of the filler is from about 2 microns median to about 15 microns. The fine particles project through the dried exterior surface of the matte release coat to form, on a microscopic scale, a surface with a micro-roughness that transfers a replicated micro-roughness to the surface of the dried top coat. This produces light scattering, resulting in a low gloss surface on the top coat.

The matte release coat formulation includes a release agent to enhance the release of the casting sheet and its matte release coat from the top coat after the dry paint transfer sheet has been completed. The release agent is produced by the polysiloxane component, which enhances free release of the clear coat from the matte release coat at elevated temperatures. As an alternative, a wax component can be included in the release coat to enhance release of the clear coat layer from the carrier sheet. Once sufficiently crosslinked, the matte release coat becomes permanently bonded to the casting sheet. The chemical matte casting sheet has a measured 60° gloss reading of 10 to 15 gloss units.

After the matte release coat has been applied to the casting sheet, the top coat layer is then coated on the release coated surface of the casting sheet. The soft laminate comprises a urethane clear coat applied to the polyester carrier film. The overall performance of the finished laminate is dictated primarily by the outer clear coat layer. The urethane layer consists of a very soft waterborne aliphatic urethane dispersion with a polymeric flatting agent. A preferred flatting agent is a urea-formaldehyde condensation polymer flatting agent. The urethane resin has a very low hardness level while being extremely tough (tensile strength) and highly extensible from elongation produced by later thermoforming. A clear coat layer comprising a urethane resin having a tensile strength range from about 3500 to about 6000 psi provides the desired level of toughness (mar resistance). A desired Sward hardness is below about 10. A harder polymer does not provide the required tactile properties and may not be sufficiently formable. The flatting agent contributes to the soft tactile feel of the finished material and contributes primarily to scratch and mar resistance performance. The flatting agent also is a major influence on the final gloss. The urethane clear coat formulation of this invention provides improvements in gloss stability in long term weathering, as well as abrasion and mar resistance and extensibility under thermoforming conditions.

The clear coat formulation includes a crosslinking agent that provides low density crosslinking within a range sufficient to provide a desired level of extensibility while maintaining extremely low gloss levels through thermoforming. The desired level of low crosslinking density of the clear coat layer is achieved if the finished layer can be elongated (under thermoforming)up to at least about 100% of its original dimension, where extensibility is measured by comparing the thickness of the original laminate with the thickness of the finished laminate. Elongation is measured using the finished laminate which is to be thermoformed. This typically includes the outer clear coat, color coat layer, and the substrate to which the decorative film has been laminated. For instance, a laminate which is stretched to one-half its original thickness doubles in surface area, which is considered to represent 100% elongation.

Testing is preferably done by forming four-inch by twelve-inch rectangular plaques on a former having a rectangular recess into which the plaques are drawn under thermoforming conditions. Thermoforming temperature is typically 320 to 330° F. The plaques are given a one inch and 2 inch draw, forming right angle corners on the sides of the formed part. If the formed part can be drawn to at least 100% without fracture of the clear coat layer, then the clear coat material is considered to have the desired level of low crosslinking density, with the proviso that the low surface gloss level is not increased during the forming step.

Another test for measuring crosslinking density uses a tensile elongation instrument which measures input force. Film thickness is separately measured and compensated for by manual calculation. Percent elongation is measured. An elongation of at least 100% is considered to produce the desired level of low crosslinking density in the outer clear coat layer.

In one embodiment, a melamine resin crosslinking agent is used and, in another embodiment, a polycarbodiimide resin is used as a crosslinking agent. Both of these crosslinking components, when used at proper levels described below, provide good crosslinking performance without excessively reducing formability. The melamine crosslinking agent, in one embodiment, comprises a liquid hexamethoxy-methylmelamine crosslinking resin, preferably the resin Cymel 303, for which good crosslinking performance is produced at about 5-15% (by weight) of the total resin solids contained in the clear coat formulation. This crosslinking agent provides improved weathering results in combination with the aliphatic waterborne polyurethane dispersion. The improvement is particularly noticeable with respect to gloss control in long-term weathering. The crosslinked film does not exhibit a significant increase in 60° gloss levels at 1240kJ xenon exposure, while the resin itself (absent the crosslinking agent) suffers an effect of doubling of the measured gloss. In another embodiment, the polycarbodiimide crosslinking resin provides similar improvements with respect to gloss control. A preferred polycarbodiimide resin is Carbodolite E-02, for which good crosslinking performance is produced at about 2 to 5% (by weight) of the total resin solids. In both instances, the crosslinking provides a soft leather-like tactile surface for the finished part, which is maintained after exposure to artificial weathering, while the non-crosslinked versions suffer noticeable deterioration in softness. The combination of the urethane binder resin and the crosslinking resin produces an outer clear coat layer having a soft, leather-like surface quality before and after thermoforming. The tactile quality of the outer surface is characterized, in part, by its low friction surface properties, having a coefficient of friction in the range from about 0.2 to about 0.5. In one test conducted on samples of film made by the process of this invention, coefficient of friction (COF) was measured for film having a desired tactile outer surface quality. The samples of film included outer clear coat, tie coat and color coat. These film samples had not been laminated or thermoformed. Static COF varied from a high of 0.412 to a low of 0.343, with an average of 0.371 (with a 0.036 standard deviation) . Kinetic COF varied from a high of 0.368 to a low of 0.343, with an average of 0.340 (with a 0.024 standard deviation). These data were measured on a Monitor Slip and Friction Instrument, Model No. 32-06-00-0001, from Testing Machines, Inc. Lamination of these film samples would not be expected to change COF data by any significant amount. COF measurements within the desired 0.2 to 0.5 range for the film produce a desirable surface friction level in the part that is ultimately thermoformed.

The flatting agent helps provide the matte finish to the finished clear coat layer. Preferably, the flatting agent can be characterized as a fine particulate filler and, in a preferred embodiment, the flatting agent comprises a polymeric flatting material, such as a condensation polymer, preferably a urea-formaldehyde condensation polymer. This particular type of flatting agent improves mar resistance and abrasion resistance and also improves weatherability better than a flatting agent comprising silica particles. The flatting agent has a particle size range from about 1 to about 5 microns and is preferably contained within the urethane resinous component in a weight percent range from about 10% to about 25% of the total flatting agent-resin solids.

Other minor components of the top coat formulation can include UV absorbers, a urethane associative thickening agent useful in controlling the viscosity of the dispersion coating, a flow additive, and organic solvents to form a film at low temperatures and to dissolve the UV components into the system. Once cast, the top coat is dried by conventional means, such as a multiple stage impinging air oven. Different drying zones of the oven can be controlled at different temperatures depending upon the drying characteristics of the top coat. In one embodiment, the preferred coat weight of the top coat is about 32 grams/m², or a dry film thickness from about 1 to about 3 mils.

One or more tie coats can then be applied to the top coat. In one embodiment, a single tie coat is applied by a gravure printing process. The tie coat improves the bond between the top coat and the underlying color coat. Preferably, an acrylic resin tie coat is used, and more preferably a modified acrylic resin solvent-based adhesive resin formulation. The tie coat is preferably dried in a multi-stage impinging air oven and dried to about 0.1 mil dry film thickness. Other materials, such as a vinyl resin, can be used for the tie coat layer. If the color coat material can be adhered directly to the polyurethane clear coat layer, then no tie coat is required. The adhesive tie coat layer is preferably applied with a gravure print, which provides a roughly 1 to 5 grams/m² coat weight.

One or more color coats are then applied either to the clear coat layer or to the tie coat layer to provide the desired color to the transfer sheet. The color coat is applied preferably at a 15-20 grams/m² coat weight to provide a thickness that helps prevent substrate color bleed-through when the material is formed. Higher coat weights can be used if bleed-through is a critical issue. The color coat also can be applied using a slot-dye, direct or reverse, and knife over-roll methods. Gravure printing can be used as well, but does not provide the desired higher coat weight for certain three-dimensionally formed parts. The finished material is wound onto a roll for subsequent lamination to the desired substrate.

Printed patterns can be made by gravure printing the clear coat or tie coat with the desired patterns and color coats. As with solid colors, if the inks have adhesion to the clear coat, then no tie coat is necessary. Each color coat or print coat layer comprises a thermoplastic and thermoformable polymeric binder material containing uniformly dispersed pigments, as is well known in the art. The preferred color coat is made of a coating containing an acrylic resin that contains a sufficient level of pigment to provide the desired color for the finished product and also to improve the finished product's resistance to UV degradation. A liquid cast weatherable color coat containing an acrylic polymer is preferred. Other polymeric materials may be used for the color coat layer, including urethanes, vinyls, and fluoropolymer/acrylic blends such as PVDF/acrylic resin systems. The color coats or print coats are dried in a multiple stage impinging air oven and, in practice, the first color coat is hardened before a second color coat or print coat is applied. In one form of the invention, the color coat comprises a polyethyl methacrylate resin, which is also dispersed with a UV absorber and appropriate solvents. Standard pigments known in the industry are used.

The decorative film is laminated either as a finished formable laminate for injection cladding or as a laminate for use in a thick sheet extrusion process. In the process for making finished laminate, the transfer foil is laminated to a substrate, typically ABS or TPO, using a hot roll laminator. The substrate also can be made from other polymeric materials, such as polycarbonate, PETG, TPO, polypropylene or acrylic resinous materials. The polymeric substrate can have a thickness in the range from about 10 to about 300 mils. A thermoformable substrate is typically between 20 to 60 mils in thickness. During lamination, the release coated polyester carrier is removed, and the finished laminate is wound into a roll. The finished laminate is then ready to be formed into a desired three-dimensional shape and injection molded. Prior to forming the laminate has a low gloss (about 3-5 on a 60° gloss meter) due to its previous contact with the matte release coat. However, the full matting effect is not seen until the film is stretched during forming and the flatting agent emerges to the surface. The minimum amount of elongation required for optimum gloss control is at least about 15%, and more preferably about 25%.

Several approaches can be used for producing a finished part by thick sheet extrusion. In one embodiment, the transfer foil is laminated onto a thin 11 mil thick polymeric sheet, such as ABS, and the release coated polyester film is removed. This material is then used as a cap sheet laminate in a thick sheet extrusion process. The cap sheet is nipped onto the molten ABS sheet as it comes through a roll stack. An embossing roll is typically used in the process to provide the required texture. An alternative embodiment for producing a thick sheet laminate involves laminating the color coated foil to thin acrylic film approximately 1 to 3 mils in thickness. The release coated carrier film is removed, leaving a thin 2.5 to 7 mil free film, which is laminated to the thick sheet and matted similar to the cap sheet construction. This process has proven to provide good qualities for embossing. In a further embodiment, the color coated foil is face laminated directly onto a molten polymeric sheet as it is being extruded.

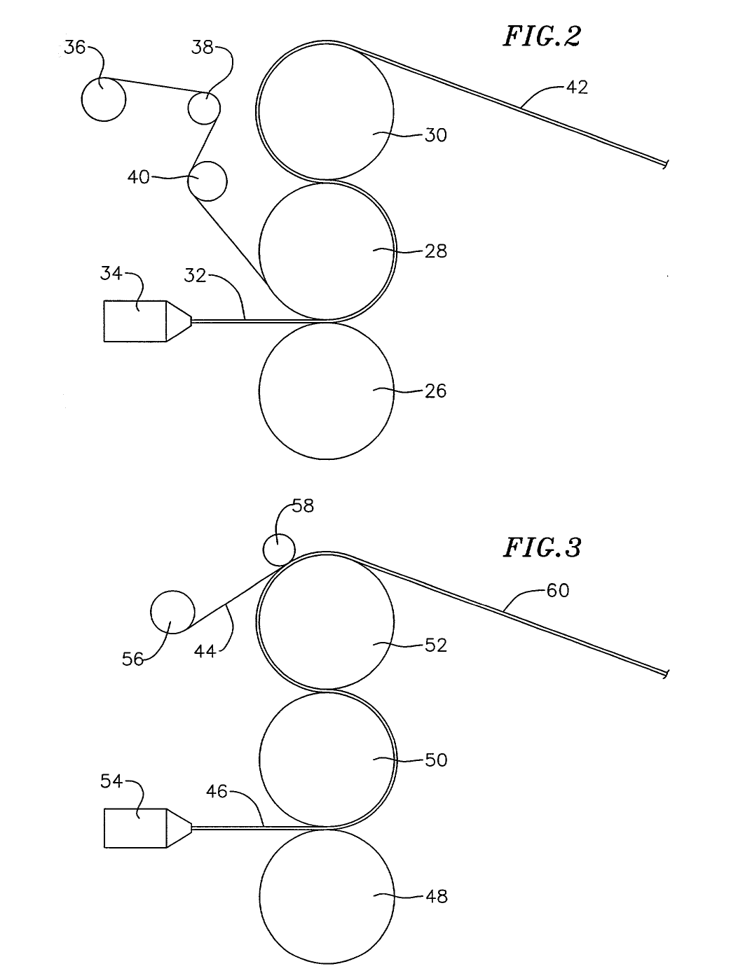

FIGS. 2 and 3 show different embodiments of a thick sheet lamination process for manufacturing low gloss interior automotive panels. The process illustrated in FIG. 2 includes a vertically disposed three roll calendaring stack comprising a lower polished roll 26, are intermediate embossed roll 28 and an upper polished roll 30. A molten extruded sheet 32 exits an extruder die 34 passing between the lower and intermediate calendaring rolls and then around the upper roll. The starting materials for the extruded sheet can comprise any of the extrudable resinous materials mentioned previously. In the illustrated embodiment, the extruded sheet is a thick substrate sheet made from a thermoformable polymeric material preferably between about 20 to about 60 mils in thickness. In the embodiment of FIG. 2, a composite low gloss laminate made by the process illustrated in FIG. 1, passes directly into the calendaring roll stack. The composite laminate, also referred to as a cap sheet laminate, passes from a supply roll 36 around guide rolls 38 and 40 and then directly between the lower and intermediate calendaring rolls for bonding to the extruded sheet as it exits the extruder die. In one lamination process the soft transfer laminate comprises a bare coat/clear coat film laminated to a thin support film, preferably a 2 mil acrylic film. The carrier film has been stripped from this laminate. The thick sheet is extruded at an extrusion temperature of about 440° F., and sheet temperature is reduced by passing between the lower and intermediate rolls. The lower roll is operated at a temperature of about 160° to 180° F. and the intermediate roll is operated at a temperature of about 216° F. The upper roll is operated at a temperature range of about 225° F. The finished sheet 42 passes downstream to a take-up roll, not shown.

FIG. 3 illustrates an alternative embodiment of a process for manufacturing a low gloss automotive interior thick sheet laminate in which a composite low gloss laminate or cap sheet 44 is laminated to a thick extruded substrate sheet 46 downstream from the extruder die. This embodiment comprises a vertically disposed three roll calendaring stack comprising a lower roll 48, an intermediate roll 50 and an upper roll 52. The cap sheet comprises a low gloss base coat/clear coat laminate similar to that described previously, in which the outer clear coat has transferred to it the low gloss surface from the micro-roughened carrier on which it was cast. The extruded substrate sheet is extruded from an extruder die 54 and passes between the lower and immediate rolls and then around the upper laminating roll. In this embodiment, the low gloss cap sheet laminate 44 passes from a supply roll 56 to a laminating roll 58 located on the extrusion line downstream from the extruder die. In this embodiment, the cap sheet is laminated to the extruded substrate sheet by passing between the laminating roll and the upper calendaring roll for bonding the cap sheet to the extruded substrate sheet. Operating conditions for the process of FIG. 3 are similar to those for FIG. 2, however, sheet temperature is reduced by passing the cap sheet into contact with the extruded sheet at a lower sheet temperature. Laminating the cap sheet downstream from the extrusion nip makes it possible to produce proper adhesion when using certain polymeric materials having a high shrinkage problem. The reduced laminating temperature produces a more uniform bonding of the cap sheet to the extruded substrate sheet. The thick sheet laminate 60 then passes downstream to a take-up roll, not shown.

The thick sheet laminate is then formed into a desired three-dimensional shape. The thermoforming process is carried out at a sheet temperature of about 330° F. During the thermoforming step, the laminate is elongated at least 15% up to about 100%, and more preferably 200%, without structural failure (fracture) of the transferred dry paint layers. Gloss measurements were taken before and after thermoforming. Prior to thermoforming the outer clear coat had a 60° gloss reading of 4.3 gloss units. Following thermoforming the exterior base coat/clear coat paint film had a uniformly distributed low gloss surface of less than about 3 gloss units measured at 60°.

### EXAMPLE 1

A matte release coat was formulated from the following components:

| Component | Parts |
|---|---|
| Desmophen A450 | 48.04 |
| Methyl isobutyl ketone (MIBK) | 9.46 |
| Isopropyl alcohol (IPA) | 9.46 |
| Microtalc MP 15-38 | 24.02 |
| BYK 370 | 0.41 |
| Cymel 303 | 6.12 |
| BYK 451 | 2.50 |
| | 100.00 |

(1) Desmophen is an acrylic polyol resin sold by Bayer.

(2) BYK 370 is a polysiloxane release aid and flow additive.

(3) Cymel 303 is a liquid hexamethoxy-methylmelamine crosslinking resin sold by American Cyanamid (Cytec).

(4) BYK 451 is a PTSA catalyst.

The matte release coat was coated on a polyester carrier and dried. The crosslinked clear coat layers from the following examples were coated on the matte release coated carrier.

### EXAMPLE 2

A first embodiment of a low gloss clear coat was formulated from the following components:

| Component | Parts |
|---|---|
| Sancure 20023 | 67.75 |
| Water | 11.95 |
| Pergopak M3 | 5.59 |
| Rhodoline 770 | 0.01 |
| Intermediate formula | 8.20 |
| Rheolate 288 | 0.30 |
| Cymel 303 | 2.70 |
| Glycol Ether DPM | 3.50 |
| | 100.00 |

(5) Sancure is an aliphatic waterborne polyurethane dispersion.

(6) Pergopak is a urea-formaldehyde condensation polymer flatting agent having a mean particle size of 4-5 microns with a >10 micron 7-13% of total.

(7) Rhodoline is a defoaming agent.

(8) Rheolate is a thickening agent for adjusting the viscosity of the dispersion coating.

The Intermediate formulation is:

| Component | Parts |
|---|---|
| Glycol Ether PM | 58.05 |
| Glycol Ether DPM | 28.59 |
| Tinuvin 1130 | 6.61 |
| Tinuvin 292 | 3.31 |
| BYK | 3.44 |
| | 100.00 |

(9) Glycol Ether PM and DPM are co-solvents to form the film at low temperatures and disperse the UV absorber.

(10) Tinuvin is a benzotriazole light stabilizer sold by Ciba Geigy (Ciba Specialty Chemicals).

### EXAMPLE 3

A second embodiment of a low gloss clear coat formulation was prepared from the following components:

| Component | Parts |
|---|---|
| Sancure 20023 | 67.75 |
| Water | 11.95 |
| Pergopak M3 | 5.59 |
| Rhodoline 770 | 0.01 |
| Intermediate formula | 8.10 |
| Rheolate 288 | 0.30 |
| Carbodilite E-02 | 2.80 |
| Glycol Ether DPM | 3.50 |
| | 100.00 |

(11) Carbodilite is a polycarbodiimide crosslinking agent sold by Nisshinbo Industries, Inc.

### EXAMPLE 4

A third embodiment of a low gloss clear coat formulation was prepared from the following components:

| Component | Parts |
|---|---|
| Sancure 20023 | 66.00 |
| Water | 11.60 |
| Pergopak M3 | 5.40 |
| Rhodoline 770 | 0.10 |
| Intermediate formula | 7.90 |
| Rheolate | 0.30 |
| Cymel 303 | 5.30 |
| Glycol Ether DPM | 3.40 |
| | 100.00 |

This example produced a clear coat film that was overly crosslinked, resulting in fracture of the outer surface layer under thermoforming that produced elongation of less than 80% percent.

What is claimed is:

1. A decorative and functional low gloss interior automotive laminate comprising of thermoformable decorative transfer sheet having a protective outer clear coat layer and an underlying base coat layer containing a dispersed pigment, and a self-supporting thermoformable resinous sheet adhered to the transfer sheet on a side there of opposite the outer clear coat, the outer clear coat having a transferred surface micro-roughness to reduce the surface gloss thereof, the outer clear coat comprising a soft urethane material of low cross-linking density containing a dispersed flatting agent, the laminate having been subjected to thermoforming or molding to elongate the laminate to at least about 15% elongation to provide thereon a three-dimensional outer surface, the outer surface of the transferred laminate having a soft tactile surface finish and a 60° surface gloss level from about 1 to about 5 gloss units.

2. The laminate according to claim 1 in which the urethane material comprises a waterborne aliphatic urethane dispersion.

3. The laminate according to claim 1 in which the outer clear coat layer is elongated between about 15% to about 200% during thermoforming.

4. The laminate according to claim 1 in which the outer clear coat is cast on and transferred from a temporary carrier sheet having a matte thermoset release layer for releasably contacting the cast outer clear coat to transfer the surface micro-roughness.

5. The laminate according to claim 1 in which the clear coat has a cross-linking density that produces at least about 100% elongation without mechanical failure of the elongated clear coat film.

6. The laminate according to claim 1 in which the clear coat material comprises a flatting agent versus resin solids ratio from about 15% to about 25% by weight.

7. The laminate according to claim 1 in which the flattening agent comprises a fine particulate polymeric material.

8. The laminate according to claim 1 in which the outer surface of the transferred laminate has a coefficient of friction from about 0.2 to about 0.5.

9. A decorative and functional low gloss interior automotive laminate comprising a thermoformable decorative transfer sheet comprising a cast urethane outer clear coat layer and an underlying base coat layer containing a dispersed pigment, and a self-supporting thermoformable resinous sheet adhered to the transfer sheet on a side thereof opposite the outer clear coat, the outer clear coat layer comprising a flatting agent dispersed in a urethane material having a low cross-linking density sufficient to allow the outer clear coat layer to elongate at least about 100% without structural failure, the outer clear coat layer having a transferred surface micro-roughness from having been cast on a temporary carrier sheet, the outer surface of the clear coat layer maintaining a 60° gloss level within the range from about 1 to about 5 gloss units after the laminate is thermoformed to a three-dimensional shape and the carrier is removed from the outer clear coat surface.

10. The laminate according to claim 9 in which the urethane material comprises a waterborne aliphatic urethane dispersion.

11. The laminate according to claim 9 in which the outer clear coat layer is elongated between about 15% to about 200% during thermoforming.

12. The laminate according to claim 9 in which the flattening agent comprises a fine particulate polymeric material.

13. The laminate according to claim 9 in which the outer clear coat is cast on and transferred from a temporary carrier sheet having a matte thermoset release layer for releasably contacting the cast outer clear coat to transfer the surface micro-roughness.

14. The laminate according to claim 9 in which the clear coat material comprises a flatting agent versus resin solids ratio from about 15% to about 25% by weight.

15. The laminate according to claim 9 in which the outer surface of the transferred laminate has a coefficient of friction from about 0.2 to about 0.5.

16. A method for making a decorative and functional low gloss interior automotive laminate comprising:
providing a temporary heat-resistant carrier sheet having a matte release coat layer with a surface micro-roughness,
casting an outer clear coat layer on the micro-roughened surface of the temporary carrier sheet, the clear coat layer comprising a soft urethane material containing a dispersed flatting agent, the outer clear coat layer having a low cross-linking density sufficient to allow the clear coat layer to elongate at least about 100% without structural failure,
bonding and underlying pigmented base coat layer to the clear coat layer
laminating the clear coat layer and the base coat layer to a self-supporting resinous sheet to the side of the laminated opposite from the clear coat layer, and
thermoforming the laminate to a three-dimensional shape, the outer clear coat layer having a transferred surface micro-roughness from having been cast on the temporary carrier sheet, the outer surface of the clear coat layer maintaining a 60° gloss level within the range from about 1 to about 5 gloss units after the laminate is thermoformed and the carrier is removed from the outer clear coat surface.

17. The method according to claim 16 in which the urethane material comprises a water-borne aliphatic urethane dispersion.

18. The method according to claim 16 in which the outer clear coat layer is elongated between about 15% to about 200% during thermoforming.

19. The method according to claim 16 in which the outer clear coat is cast on and transferred from a temporary carrier sheet having a matte thermoset release layer for releasably contacting the cast outer clear coat to transfer the surface micro-roughness.

20. The method according to claim 16 in which the clear coat material comprises a flatting agent versus resin solids ratio from about 15% to about 25% by weight.

21. The method according to claim 16 in which the matte release layer on the carrier comprises a thermoset resin containing a polymeric flatting agent.

22. The method according to claim 16 in which the outer surface of the transferred laminate has a coefficient of friction from about 0.2 to about 0.5.
